(19) United States
(12) Patent Application Publication
(10) Pub. No.: US 2012/0273634 A1
(43) Pub. Date: Nov. 1, 2012

(54) Belt Holding Tool

(75) Inventors: Jacob Hanson, Owatonna, MN (US); Jose Barrios, Owatonna, MN (US)

(73) Assignee: SPX CORPORATION, Charlotte, NC (US)

(21) Appl. No.: 13/093,943

(22) Filed: Apr. 26, 2011

(51) Int. Cl. H01F 7/02; B23P 17/00; F16B 47/00

(52) U.S. Cl. 248/205.4; 248/206.5; 29/559

(57) ABSTRACT

A tool for holding a belt of an engine during belt replacement. The tool includes a base and a belt holding portion. A magnet can be included in a magnet receiving portion of the base so that the tool can be coupled to the pulley. The tool may also be clipped to the pulley so that the belt can be held in place during replacement. The belt holding portion may also be curved similar to the curvature of the pulley.

### FIELD OF THE INVENTION

The present invention relates generally to a belt holding tool. More particularly, the present invention relates to a belt holding tool that holds an engine belt to a pulley.

### BACKGROUND OF THE INVENTION

A vehicle engine includes pulleys with belts, such as timing belts or cam belts, that control timing of the engine's valves. They also include accessory belts that drive the alternator, water pump, air conditioning, power steering and other engine components. These belts need to be replaced at certain intervals or it can result in a complete breakdown or failure of the engine, which can strand a driver on a highway. The timing and accessory belts are also known as serpentine or V-type belts. Replacement of these belts require them to removed and replaced back on the various pulleys and often are difficult in tight locations. At time, it may take more than one mechanic to install the belts due to the need of an “extra pair” of hands to hold a portion of the belt in place. Accordingly, it is desirable to provide a belt holding tool that can provide this “extra pair” of hands so that only one mechanic is needed to install the belts.

### SUMMARY OF THE INVENTION

The foregoing needs are met, to a great extent, by the present invention, wherein in one aspect an apparatus is provided that in some embodiments include a belt holding tool that can be coupled to the pulley of the engine and hold a portion of the belt while another portion is being installed on the pulleys.

In accordance with one embodiment of the present invention, a belt holding tool is provided having a base having a magnet receiving portion, a magnet disposed in the magnet receiving portion, and a belt holding portion coupled to the base and having a belt retaining surface.

In accordance with another embodiment of the present invention, a belt holding tool is provided and includes means for supporting the tool to a pulley of an engine, means for receiving a magnet, and means for holding a portion of a belt coupled to the means for supporting, the means for holding having a belt retaining surface.

In accordance with yet another embodiment of the present invention, a method of holding a replacement belt of an engine is provided and includes the steps of placing the belt on a pulley of the engine, coupling a belt holding tool to the pulley with a magnet positioned in a base of the belt holding tool, and holding the belt in place with a belt holding portion connected to the base.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates a plan view of the belt holding tool 10 according to an embodiment of the invention.

FIG. 2 illustrates a plan view of the belt holding tool 10 according to an embodiment of the invention.

FIG. 3 illustrates a plan view of the belt holding tool according to another embodiment of the invention.

FIG. 4 illustrates the belt holding tool coupled to a pulley according to an embodiment of the invention.

FIG. 5 illustrates the belt holding tool according to yet another embodiment of the invention.

FIG. 6 illustrates the belt holding tool 10 according to still another embodiment of the invention.

FIG. 7 illustrates the belt holding tool according to another embodiment of the invention.

### DETAILED DESCRIPTION

The invention will now be described with reference to the drawing figures, in which like reference numerals refer to like parts throughout. An embodiment in accordance with the present invention provides a belt holding tool that can be used to hold a portion of the belt while another portion is being installed on a pulley of the engine.

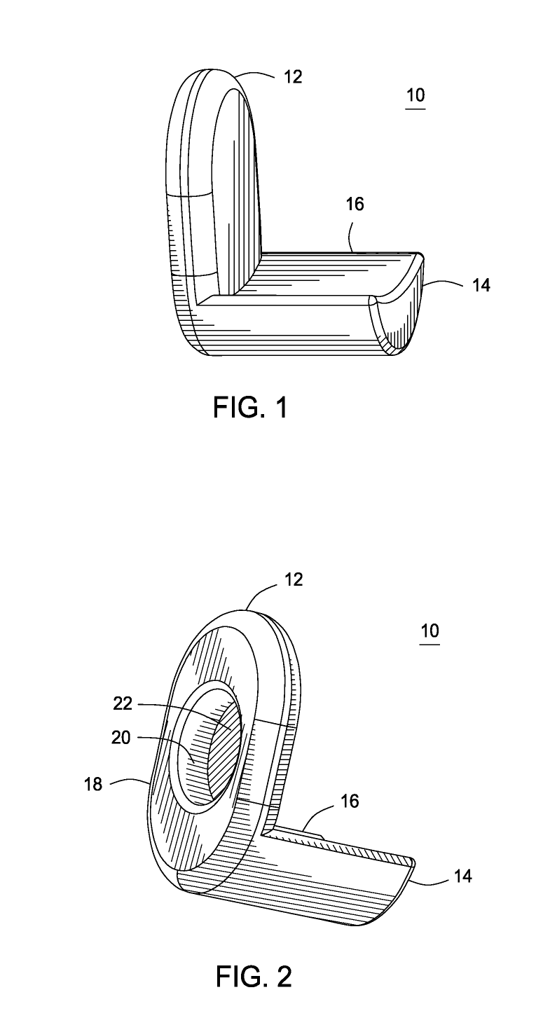

FIGS. 1 and 2 illustrate a plan view of the belt holding tool 10 according to an embodiment of the invention. The belt holding tool 10 includes a base 12 and a belt support portion 14. The belt holding tool 10 can be made of any material such as a polymer, wood, metal, steel, ceramic or any other suitable material that can hold a belt. Further, the belt holding tool 10 may be made to match the color of the pulleys or any color desired by the mechanic.

The base 12 is the part of the belt holding tool 10 that is coupled to the pulley. The base 12 can be any shape including round, oval, rectangular, or square, etc. In one embodiment, the base 12 includes a back side 18 that includes a magnet receiving portion 20. The back side 18 is constructed and designed to mate with a pulley of a vehicle or any part of the engine desired by the mechanic. Although the back side 18 is shown to be flat, it can be curved or have indentions to receive a portion of the pulley. The magnet receiving portion 20 is constructed and designed to receive a magnet of various size and shape. The magnet can be any shaped, strength, size or type (permanent magnets, temporary magnets and electromagnets) so long as it can allow the belt holding tool 10 to mate with the pulley or the engine.

In one embodiment, the magnet receiving portion 20 may be hollow throughout the base so that the magnet may be held in place by friction (friction fit) or glued on the sides of the magnet receiving portion or any other means to hold the magnet in place. In another embodiment, the magnet receiving portion may include a magnet supporting surface 22 so that the magnet is seated into the magnet receiving portion 20 and rests on the magnet supporting surface.

The belt support portion 14 includes a belt retaining surface 16. The belt retaining surface 16 is constructed and designed to mate with the belt in a releasable manner. That is, the belt may touch the belt retaining surface 16 surface constantly when the tool 10 is being used or touched it temporally during use. The belt retaining surface 16 may include a textured surface, such as being knurled or be smooth depending on the need of the mechanic. Further, the belt retaining surface 16 may be generally flat or curved shaped. The curve shape may have a similar curve angle to a pulley of the engine. The curve shape helps to better hold the belt in place depending where the tool 10 is coupled to the pulley.

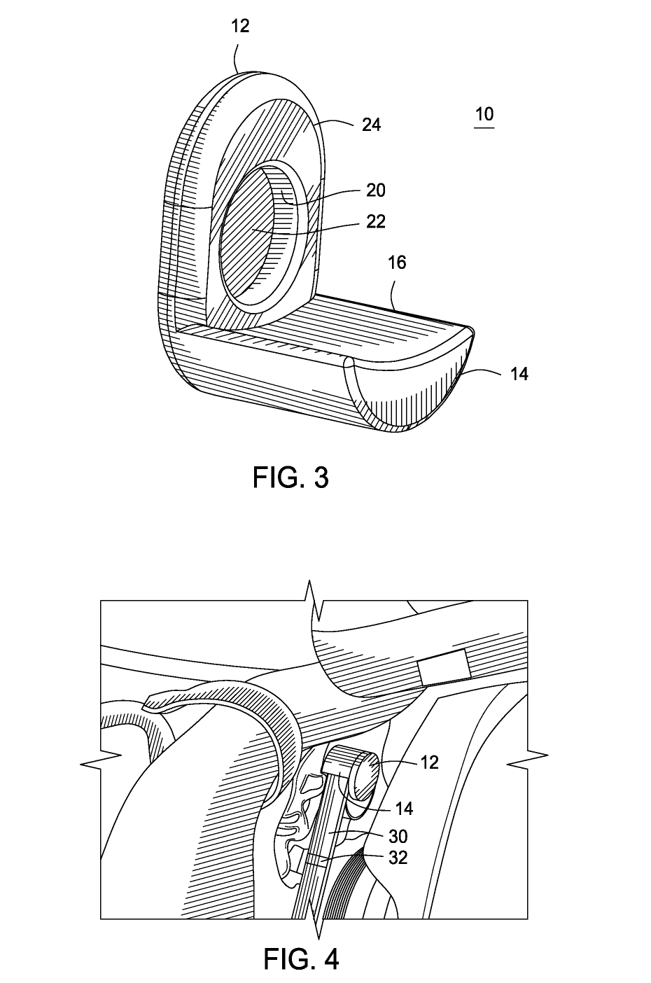

FIG. 3 illustrates a plan view of the belt holding tool 100 according to another embodiment of the invention. In this embodiment, the magnet receiving portion 20 is on a front side 24 of the base 12. In one embodiment, the magnet receiving portion 20 may be hollow throughout the base so that the magnet may be held in place by friction (friction fit) or glued on the sides of the magnet receiving portion or any other means to hold the magnet in place. In another embodiment, the magnet receiving portion may include a magnet supporting surface 22 so that the magnet is seated into the magnet receiving portion 20 and rests on the magnet supporting surface.

Although some of the embodiments herein includes a magnet receiving portion, the invention also contemplates that the base or a portion of the base can be made from a magnet. Thus, obviating the need for a magnet receiving portion. In another embodiment, the magnet may be in bedded in the base itself and thus can not be seen by the user. By using a magnet, the belt holding tool 10 can easily release from the pulley when belt is replaced by the mechanic.

FIG. 4 illustrates the belt holding tool 10 coupled to a pulley 30 according to an embodiment of the invention. The belt can be received between the pulley 30 and the belt support portion 14 of the belt holding tool 10. The belt holding tool is coupled magnetically to the pulley 30 so that belt support portion 14 holds a portion of the belt in place while the mechanic works to put the other portion onto other pulleys of the engine. Although the belt holding tool 10 is shown placed at a top portion of the pulley, it can be placed anywhere along the pulley so long as the belt support portion 14 can hold the belt in place.

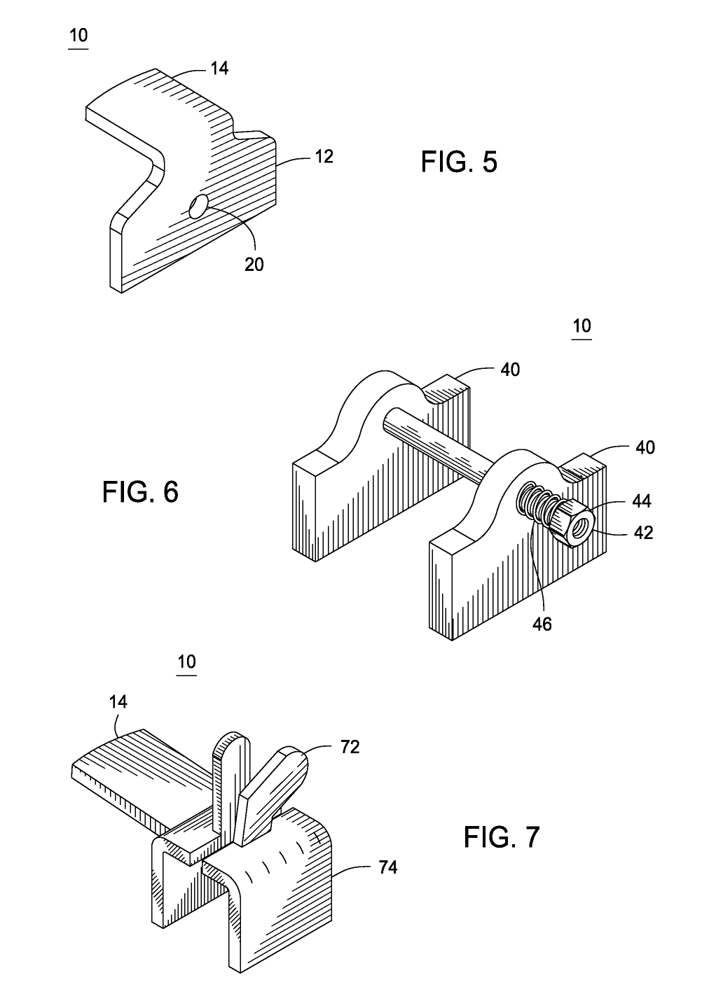

FIG. 5 illustrates the belt holding tool 10 according to an embodiment of the invention. In this embodiment, belt holding tool 10 includes the base 12 having the magnetic receive portion 20. The belt support portion 14 is integrally formed with the base. Alternatively, the belt support portion 14 and the base may be welded or glued together or by any other means. In another embodiment, the base or a portion of the base can be made from a magnet.

FIG. 6 illustrates the belt holding tool 10 according to still another embodiment of the invention. In this embodiment, the belt holding tool 10 includes two holding portions 40 coupled together via a screw assembly 42. The screw assembly can include a screw 44 and a spring 46. By rotating the screw 44 in one direction, the holding portions come together and by rotating the screw 44 in a second direction, the holding portions come apart or away from each other. In operation, the belt holding tool 10 in this embodiment can be clipped to the pulley in order to hold the belt between the pulley and the screw assembly 42.

FIG. 7 illustrates the belt holding tool 10 according to still another embodiment of the invention. In this embodiment, the belt holding tool 10 includes two clip portions 74 coupled together via a spring assembly (not shown). The clip portions 74 may be moved apart by the mechanic pressing tabs 72 together. By releasing the tabs 72, the spring will bias the clip portions 74 together, thereby holding the tool 10 in place on the pulley or other parts of the engine. The belt support portion 14 can protrude from one of the clip portions 74. The belt support portion 14 can be integral with the clip portion 74 or welded thereon.

In operation, the mechanic can place the belt holding tool 10 on the desired portion of the pulley by simply pressing the tabs together and releasing them. Thus, the clip portions can clip to the a portion of the pulley such as the outer portion of the pulley.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A belt holding tool, comprising:
a base having a magnet receiving portion;
a magnet disposed in the magnet receiving portion; and
a belt holding portion coupled to the base and having a belt retaining surface.

2. The tool of claim 1, wherein the magnet receiving portion is on a back side of the base and a magnet supporting surface is on a front side of the base making the base solid on the front side.

3. The tool of claim 1, wherein the magnet receiving portion is on a front side of the base and a magnet supporting surface is on a back side of the base making the base solid on the back side.

4. The tool of claim 1, wherein the belt retaining surface is curved at an angle.

5. The tool of claim 1, wherein the base and the belt holding portion are integral.

6. The tool of claim 1, wherein the belt holding portion holds a belt of the vehicle in place.

7. The tool of claim 1, wherein the base is designed to mate with a pulley of an engine.

8. The tool of claim 4, wherein the curved angle is similar to a curve of a pulley of an engine.

9. The tool of claim 1, wherein the magnet is held in the magnet receiving portion through friction fitting or an adhesive.

10. A belt holding tool, comprising:
means for supporting the tool to a pulley of an engine;
means for receiving a magnet; and
means for holding a portion of a belt coupled to the means for supporting, the means for holding having a belt retaining surface.

11. The tool of claim 10, wherein the means for receiving is on a back side of the means for supporting and a magnet supporting surface is on a front side of the means for supporting making the means for supporting solid on the front side.

12. The tool of claim 10, wherein the means for receiving is on a front side of the means for supporting and a magnet supporting surface is on a back side of the means for supporting making the means for supporting solid on the back side.

13. The tool of claim 10, wherein the belt retaining surface is curved at an angle.

14. The tool of claim 10, wherein the means for supporting and the means for holding are integral.

15. The tool of claim 10, wherein the means for holding holds a belt of the engine in place.

16. The tool of claim 10, wherein the means for supporting is designed to mate with the pulley of the engine.

17. The tool of claim 13, wherein the curved angle is similar to a curve of the pulley of the engine.

18. The tool of claim 11, wherein the magnet is held in the means for receiving through friction fitting or an adhesive.

19. A method of holding a replacement belt of an engine, comprising the steps of:
placing the belt on a pulley of the engine;
coupling a belt holding tool to the pulley with a magnet positioned in a base of the belt holding tool; and
holding the belt in place with a belt holding portion connected to the base.

20. The method of claim 19, wherein the holding the belt is accomplished without using a hand of a user.
